(19) United States
(12) Patent Application Publication
(10) Pub. No.: US 2008/0162376 A1
(43) Pub. Date: Jul. 3, 2008

(54) LIMITED NETWORK FOR FACILITATING COMMUNICATION OF INFORMATION RELEVANT TO ANALYSIS OF A SELECTED INDUSTRY ELEMENT

(76) Inventor: Thomas Roulston, Orange Village, OH (US)

Correspondence Address: FAY SHARPE LLP, 1100 SUPERIOR AVENUE, SEVENTH FLOOR, CLEVELAND, OH, 44114, US

(21) Appl. No.: 11/968,243

(22) Filed: Jan. 2, 2008

Related U.S. Application Data
(60) Provisional application No. 60/878,235, filed on Jan. 3, 2007.

(51) Int. Cl. G06Q 40/00

(52) U.S. Cl. 705/36 R; 705/35

(57) ABSTRACT

A method and network system is provided for limited communication of information relevant to analysis of a potential investment. A community manager facilitates open source information gatherings for particular subjects relevant to the investment decision and includes organizing a limited community forum of investment analysts interested in the particular subject and capable of professionally evaluating the investment decision. An expert community chair directs communication between any member of the forum and a third party source of information relevant to the particular subject or the investment decision. Regularly scheduled conferences include the community manager, community chair and community forum comprising discussions relevant to a particular subject and the investment decision. Alternatively, the conference includes individual and sequential limited participation by the expert third party sources.

### TECHNICAL FIELD

The present embodiments relate to communication networks with predetermined limits as to both content and network membership, particularly useful in buyside research implementations and analysis of a selected industry element usually with regard to a potential investment therein.

### BACKGROUND

The acquisition of knowledge relevant to the health and future of a business element or other entity being analyzed and considered for possible investment is an objective that can be accomplished in many ways. Most known methods of acquisition were a result of formalized research relative to the history and operation of industry elements such as a particular company, as well as the demands and forces placed on that business by its environment. The data was acquired by formalized research operations in support of sellside brokerage firms reporting on the companies, providing income models in contrast thereto, all to support and enhance the desirability of a stock transfer action generating a commission to the benefit of the buyer or seller's brokerage agent. Unfortunately, some of the data that would be used in support of the subject business analysis was acquired from investment bankers who supplied the relevant information while promoting an investment in their same banking customer. Such a communication has been judged to be at least a conflict of interest against the unbiased supply of information to a potential broker by promoting the purchase of offerings in which the investment banker had a substantial financial stake. The conflict of interest was eventually recognized as expensively unlawful and to insure compliance with operational standards that would avoid such conflicts, sellside research became unable to access significant resources that might prove useful in the analysis of the desirability and profitability of a potential investment.

As accurate and conclusive knowledge of such matters was and always will be highly important as a basis for any analysis of a potential investment, the means for acquisition of the necessary knowledge has had to adapt in a manner to avoid the appearance of such conflicts.

Brokers and other such sellside operators, being unable to access many traditional forms of acquisition of the knowledge have moved away from sellside brokerage work, and into fund management where management performance would be compensated not only by a commission but also by fund profitability. In other words, seaside brokers began moving to limited fund buyside managers whose performance was compensated by fund profitability as opposed to mere transaction commissions. These buyside managers and analysts still require accurate information about the industries they consider and so are still faced with the problem of how to acquire the best information available to perform their buyside management obligations.

There is thus a need for a networking system to communicate among sources of such relevant information in a manner to facilitate both in time and content, an efficient communication of the relevant information.

There is also a need for enhancing communication in conferencing with representatives of a plurality of target analysis business entities related by subject matter to a collection of buyside managers where the managers may selectively conference, virtually and electronically, and separately and individually in a sequential manner, with the representatives, for enhanced efficiencies in the conferencing by both limited participation by the representative, and simultaneous collective communication by the buyside managers.

### SUMMARY

A limited communication network is provided for facilitating communication of information relevant to analysis of potential investment. A community manager facilitates open source information gathering for a particular subject relevant to the investment decision and includes organizing a limited community forum of investment analysts interested in a particular subject and capable of professionally evaluating the investment decision. A community chair comprising an expert in the particular subject based upon career experience facilitates direct communication between any member of the forum and the third party source of information relevant to the particular subject or the investment decision. Regularly scheduled conferences include the community manager, the community chair and a community forum comprising discussions relevant to the particular subject and the investment decision.

In accordance with another embodiment, the virtual conference is established for enhanced communication between buyside managers and representatives of a plurality of business entities related by subject matter. In a conference dedicated to the particular subject matter, a plurality of industry representatives for the distinct business entities are scheduled for separate and individual presentations/discussions sequentially to the buyside managers, in a virtual manner, i.e. electronically and remotely from a location apart from the buyside managers. The extent of the conference thus comprises the participation of the buyside managers throughout the entire time of the virtual conference but only limited participation for a portion of the conference by the distinct industry representatives.

### BRIEF DESCRIPTION OF THE DRAWINGS

FIG. 1 is a block diagram representing a limited communication network comprised of segregated investment subjects, each individually connectable to a vertical network comprised of a community chair, a community manager and a plurality of analysts from buyside institutions;

FIG. 2 is a block diagram of a virtual conference comprised of a plurality of buyside managers and a selected set of business entity representatives; and

FIG. 3 is a flowchart identifying a method of conducting a virtual conference between a limited set of buyside managers and sequential presentations from selected entity representatives having a common subject matter for the conference.

### DETAILED EMBODIMENTS

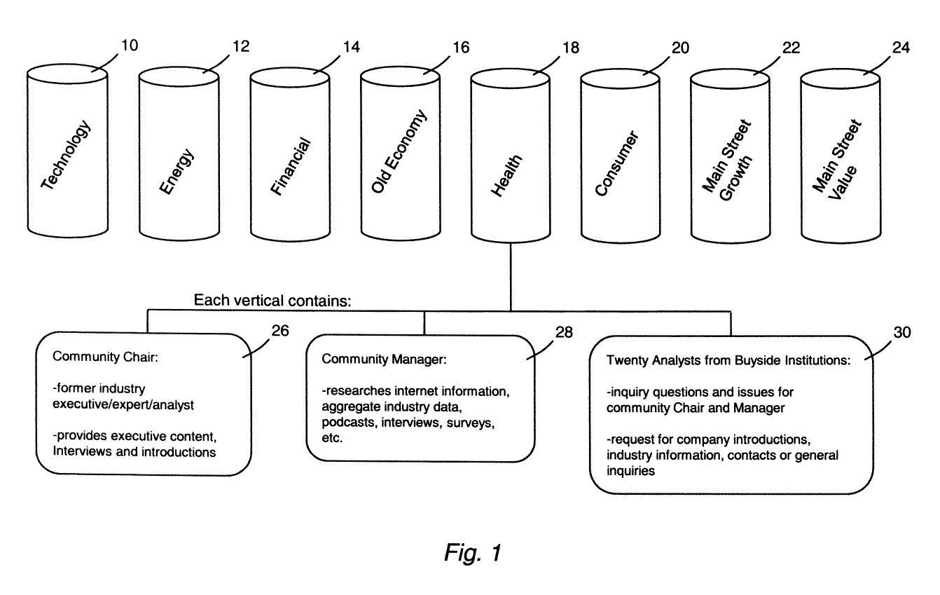

With particular reference to the Figures, FIG. 1 illustrates an industry vertical network comprising a limited communication network for facilitating the communication of information relevant to analysis of industry elements for consideration and analysis for potential investment by buyside institutions. Possible investment subjects are distributed according to industry such as Technology 10, Energy 12, Financial 14, Old Economy 16, Health 18, Consumer 20, Main Street Growth 22 and Main Street Value 24. Such industry subjects are known areas for buyside analysis. Each listed industry is intended as a potential subject of analysis by the communication network in an expert manner by the formation of a network limited in both the subject matter content and by the limiting of the members that may participate in the network.

Exemplary subjects included in the various subject groups may comprise:

### Technology

Software

Hardware

Electronic Manufacturing

Telecom

Information Technology

Web/Internet

Imaging Technology

Media

### Energy

Utilities

Oil/Natural Gas

Exploration and Production

Technology/Equipment

### Financial

Banks (National, Regional, S & L)

Brokerages

Consumer Finance

Insurance

Insurance/Nonlife

Real Estate

REITs

### Consumer

Appliances

Apparel/Clothing/Sporting Goods

Beverage

Food/Tobacco

Electronics (Retail)

Entertainment/Leisure

Hardware

Home furnishings/House wares/Accessories

Household Products

Lodging/Travel

Office Supplies

Personal Care

Packaging and Containers

Services—Advertising

Services—Communications

Restaurants

Retail—Department stores/Discount stores

Retail—Drug and Food

Retail—Specialty

### Health

Biotechnology

Drug manufacturers

Drug manufacturers—Generics

Hospitals

Managed Health Care

Medical Appliances and Equipment

Medical Instruments and Supplies

Medical Laboratories and Research

### Old Economy

Aerospace

Auto/Auto Parts

Construction

Chemicals

Electronics (Wholesale)

Metals/Mining

Paper/Forest Products

Machinery/Parts

Business Services

Business Equipment

Conglomerates

FIG. 1 shows Health 18 as the subject of the moment in the vertical network, but no matter which is involved, each industry virtual network is comprised of a community manager 28 responsible for facilitating open source information gathering for a particular subject relevant to a potential investment within the subject industry. The community manager 28 organizes a limited community forum of analysts from buyside institutions who are interested in the particular subjects of the specific network and who are capable of professionally evaluating a potential investment decision. A community chair 26 is also included within the network and comprises an expert in the subject matter relevant to the industry based upon career experience within that industry. The community chair also facilitates direct communication between any member of the forum and a third party source of information, already known (usually personally) and readily accessible to the community chair 26, and relevant to the particular subject or the investment analysis. Regularly scheduled conferences, either personal or electronic establish a virtual network for the subject communication network that includes the community manager 28, the community chair 26 and the community forum members 30 discussing relevant subjects to the particular industry and relevant investment analysis therefore.

The composition of the community forum 30 is limited by the community manager to a preselected number and identity of investment analysts who within the opinion of the community manager will most likely provide a highly efficient expert network in the acquisition of the desired knowledge important to the analysis in their investment decision making process (twenty analysts is merely an example). Accordingly, the community manager 28 limits the population of the forum and thus the number of information sources participating in network communications. The community chair 26 provides a limit on the discussions relevant to the particular subject and thus provides a limit on the content of the network communications. Alternatively, the community manager may occasionally invite an industry expert as an alternate source of information within the network but primarily, the community manager is the facilitator of the supply of open source information to the more expert analysis of other community forum members.

In one embodiment, the network comprises an on-line interaction comprising remote electronic communication presenting an opportunity for the network participants to engage and interact wherein the interaction subjects include correct industry news and channel checks, concierge-style response from industry vertical chairmen and community managers, peer interaction on topics of mutual interest and due diligence, and timely check and surveys on priorities result feedback. In addition to the conferencing, a secure on-line platform is provided which allows members to read research an idea from companies and bulletins, monitor industry chatter posted from community manager sources, post questions or request fact checking and channel checks, receive updates for the monthly call, and query the vertical chairman or peers. In the monthly research call, research agendas are provided which include a customer requested mix of content designed to cover a particular important research area. The participant clients, such as the buyside institutions, can identify and prioritize research topics based on identified important issues. The industry vertical chairman 26 regularly evaluates key industry topics and conducts surveys with vertical participant clients 30 to determine what to discuss and the depth of coverage. Key industry guest speakers are targeted at requested area issues. Key industry guests may be current or former executives, industry consultants, trade associations or government oversight contacts. Follow-up comprising one-on-one contact with participants may be provided for more depth and answer to follow-on questions.

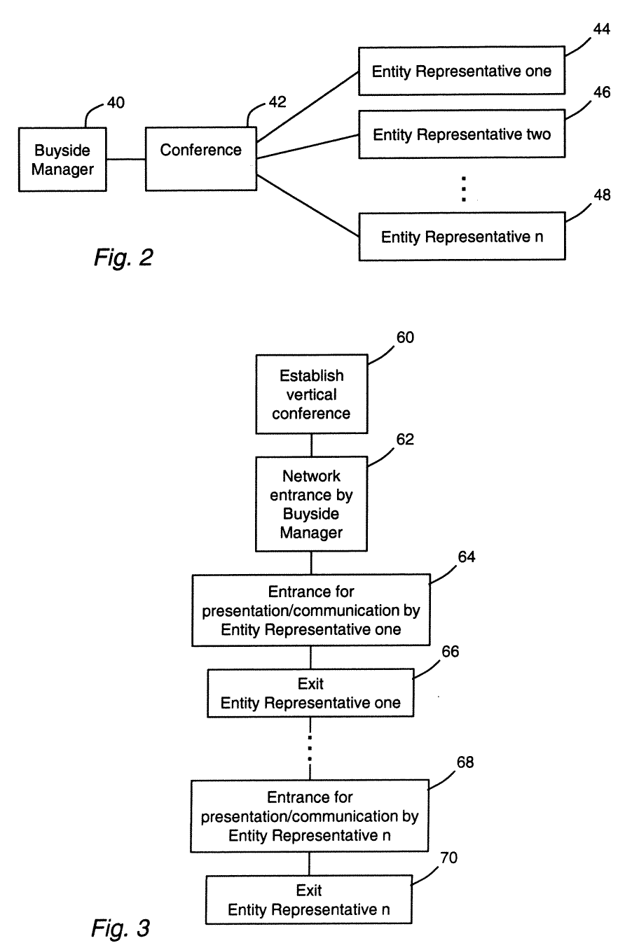

With reference to FIGS. 2 and 3, the particular form of a virtual conference is illustrated which especially maximizes time efficiencies for the participants. Most industry conferences comprise one-on-one personal participation between a representative of business entities and industry analysts attending the conference at a specific conference location. The required time for engagement within the conference by industry representatives is usually highly inefficient in that all of the entity representatives for the conference are involved concurrently, often many in a wait state while a single entity representative is involved in presentations/discussions/communication. FIG. 2 details a virtual conference where a plurality of buyside managers 40 participate electronically on-line in the conference 42 (e.g. phone and/or computer) but only selected entity representative one 44, representative two 46, and representative n 48 only participate in the conference from a remote location for a portion of the conference, limited by a specific time. Accordingly, a particular entity representative receives a dedicated time for participation within a window which allows for the representative to make the representation of a subject matter for which it is invited to participate and then leave the conference. The conference may comprise the establishment 60 of a virtual conference in a vertical network such as is shown in FIG. 1. The buyside managers 40 typically will initially enter the conference which can be organized by the community chair 26 or manager 28. At a point in time, a singular entity representative enters 64 the virtual conference for its presentation, and upon conclusion thereof, will exit 66. All intended representatives 1-n may then individually and sequentially participate 68 and then exit 70.

For example, if the conference subject were the steel industry, ten different steel companies may have representatives, each individually and sequentially reporting to buyside analysts on the state of their respective companies and engaging in dialog with the analysts on their comments, but then upon completion, can exit the conference so that any one representative is only involved and engaged during its time of participation. Alternatively, ten different companies in different parts of the supply and distribution chain for steel could be the representatives. The only limitation is that there is some association by subject matter to assure some common correspondence for the benefit of the buyside analysts.

Alternatively, several of the analysts may not have an interest in a number of the business entity representatives, so that by providing a definite, structured in time and content rotation, some analysts need only participate for the desired time slots.

Yet another alternative is that the conference 42 may comprise a plurality of different phone lines so that a single analyst may directly speak with a single industry representative, and the rotation would be between different individual analysts and representatives, respectively.

As above, any such a virtual conference is not wide open but is limited to select groups of buyside managers and entity representatives. Typically, the buyside managers are institution analysts which pay a fee for participation within the conference, which fee guarantees a limit in the participating analysts and dedicated subject matters for which the entity representatives are particularly associated as a business entity.

A consequence of such a network is a group of highly knowledgeable and informed experts, led by an experienced chair, organized by a skillful manager, for the direct communication of specialized, focused information between relevant industry sources and investment analysts.

A further consequence is the elimination of prior, intermediate research functions and agencies, which primarily filled the desired information acquisition and supply duties to sellside broker agencies.

Yet other consequences are substantial advances in time savings for the participants, cost savings from such efficiencies in a virtual network and the improved quality of the information flow.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A limited communication network for facilitating communication of information relevant to analysis of a potential investment comprising:
a community manager for facilitating open source information gathering for a particular subject relevant to the investment decision and including organizing a limited community forum of investment analysts interested in the particular subject and capable of professionally evaluating the investment decision;
a community chair comprising an expert in the particular subject based upon career experience therein and wherein the community chair facilitator directs communication between any member of the forum and a third party source of information relevant to the particular subject or the investment decision; and,
wherein regularly scheduled conferences including the community manager, community chair and community forum comprise discussions relevant to the particular subject and the investment decision.

2. The network of claim 1 wherein communication system comprises a vertical network.

3. The network of claim 1 wherein limited forum comprises an industry grouping.

4. The network of claim 1 wherein community manager hosts regular conference calls.

5. The network of claim 1 wherein limited community forum is limited by the community manager to a preselected number and identity of investment analysts.

6. The network of claim 1 wherein the community chair provides a limit on the discussions relevant to the particular subject.

7. A virtual conference method for rotating a selected plurality of entity representatives through conference participation, comprising:
establishing a virtual conference for interactive communication between a selected set of buyside entities and industry experts;
limiting industry expert participation in the conference by time and duration wherein a first individual expert enters the conference at a preselected time known to the buyside entities and exits the conference after a preselected duration of participation, and a second individual expert enters the conference after the exit of the first expert, wherein a plurality of experts are individually and sequentially engaged by the plurality of buyside entities.

8. The method of claim 7 wherein the business entity representatives and the buyside entities are remotely located for virtual conference participation.

9. The method of claim 7 wherein the business entity representatives are all associated by a common subject matter.

10. The method of claim 9 wherein the buyside entities are associated by a common interest in the common subject matter.
